(19) United States
(12) Patent Application Publication
(10) Pub. No.: US 2013/0213048 A1
(43) Pub. Date: Aug. 22, 2013

(54) DIESEL ENGINE/GAS TURBINE COMPOUND ENGINE FOR A MEANS OF TRANSPORT

(71) Applicant: Airbus Operations GmbH, (US)

(72) Inventor: Stefan Stücki, Munchen (DE)

(73) Assignee: Airbus Operations GmbH, Hamburg (DE)

(21) Appl. No.: 13/852,046

(22) Filed: Mar. 28, 2013

Related U.S. Application Data
(63) Continuation of application No. PCT/EP2011/066948, filed on Sep. 29, 2011.

(30) Foreign Application Priority Data
Sep. 29, 2010 (DE) 10 2010 046 850.9

(51) Int. Cl. F02B 63/00

(52) U.S. Cl. CPC F02B 63/00
USPC 60/772; 60/39.21

(57) ABSTRACT

A compound engine for a means of transportation, includes a diesel engine and a gas turbine with at least one compressor and with at least one turbine. The diesel engine and the gas turbine are interconnected in such a manner that during continuous duty operation the compound engine is configured to be operated only by way of the diesel engine, and the diesel engine is optionally operated on its own or together with a compressor and a turbine of the gas turbine as a turbocharger for the diesel engine. The compound engine is configured to be operated by way of the diesel engine or the gas turbine.

### CROSS-REFERENCE TO RELATED APPLICATIONS

The present application is a continuation of International Application No. PCT/EP2011/066948, filed Sep. 29, 2011, which claims priority from German Patent Application No. 10 2010 046 850.9, filed Sep. 29, 2010, the disclosures of which are hereby incorporated herein by reference.

### FIELD OF THE INVENTION

The invention relates to an engine in a means of transport. In particular, the invention relates to a compound engine comprising a diesel engine and a gas turbine, to the use of such a compound engine in a means of transport, to a means of transport with such a compound engine, and to methods for driving a means of transport with such a compound engine.

### BACKGROUND OF THE INVENTION

Both diesel drives and gas turbine drives are used in the present-day state of the art.

Diesel technology is in widespread use as a drive in motor vehicles, in aircraft and in ships or boats. Said diesel technology is characterized by high efficiency; however, the engines are usually comparatively heavy. In particular in the case of aircraft the heavy mass can result in increased energy consumption and increased expenditure.

In order to improve the output of diesel engines, in addition a turbocharger can be used. A turbocharger comprises an exhaust gas turbine that uses the energy from the exhaust air of the engine in order to drive a pre-compressor that in the engine increases the mixture throughput per work cycle, thus increasing the output of the engine. Turbochargers are, in particular, known in motor vehicles and are in widespread use.

Gas turbine technology is, in particular, used in propeller aircraft; however, for example, shaft power turbines are also used in turboprop aircraft, helicopters and heavy vehicles such as tanks. A method for operating such a gas turbine is described in WO 2009/040112 A2. Gas turbines normally comprise a compressor, a combustion chamber, for example as described in DE 103 43 049 B3, and a turbine.

The efficiency of the gas turbine depends on the operating point or on the load point.

### BRIEF SUMMARY OF THE INVENTION

An aspect of the invention provides a more fuel-efficient drive for a means of transport.

According to a first aspect of the invention, the compound engine comprises a diesel engine and a gas turbine, wherein the diesel engine and the gas turbine are interconnected and interact in such a manner that part of the gas turbine can be used as a turbocharger for the diesel engine.

This provides an advantage in that the compound engine can meet both peak load requirements, for example during takeoff of an aircraft, and continuous duty requirements, for example during cruise flight of an aircraft. By means of this shared use of system components by the gas engine and the diesel engine, in particular of one or several compressors and one or several turbines, weight and thus also materials, energy and costs can be saved. In particular, the drive is fuel-efficient.

Instead of the diesel engine, some other piston engine can also be used, for example a spark ignition engine or a gas engine. Individual or several gas turbines can be combined with individual or several diesel engines, and individual or several compressors and individual or several turbines can be used as part of the turbocharger for the diesel engine. This can be advantageous to make it possible to provide redundant drive components in the system.

Gas turbines have a significantly better power to weight ratio than diesel engines. They are therefore used in particular for peak load requirements. However, in base load operation, for example in cruise flight of a passenger aircraft, a gas turbine is less efficient than a diesel engine.

Therefore, while for short-term peak loads gas turbine technology is better suited, for base load operation during normal travel the efficient, but heavy, diesel engines are better suited.

In order to improve the output of the drive, the turbine can be switched on in addition to the diesel engine. In this arrangement the exhaust gas of the diesel engine can be further used by one or several power turbines.

According to an exemplary embodiment, the gas turbine of the compound engine comprises at least two separate compressors and two turbines. In this arrangement the compressors and turbines are switched in parallel on separate shafts, and at least one compressor and one turbine can be used as part of the turbocharger for the diesel engine. In the turbocharger system, normally the air mass flowing through the system, and in particular through the compressor and the turbine, are considerably less than those of a gas turbine. A gas turbine can, for example, have an air mass flow of 7 kg/s, while the diesel engine in turbocharger operation can require an air mass flow of 1 kg/s. Corresponding throttle valves can be used in order to be able to provide lesser air mass flows. Likewise, the rotary speeds differ, depending on the mode in which the compressor and the turbine operate. In turbocharger operation approximately a third of the maximum rotary speed is required. In gas turbine operation the rotary speed can, for example, be 14000 RPM, while in turbocharger operation it can be 4700 RPM.

According to an exemplary embodiment, the gas turbine comprises a shared combustion chamber for the turbines. Shared use in turn saves weight, materials and expenditure for the system. However, it is also possible, for example in order to produce redundant systems, for several combustion chambers to be installed. In this arrangement it is possible in each case for a compressor and a turbine to be connected by way of a combustion chamber, or for some compressors and turbines to comprise separate combustion chambers, while other compressors and turbines have a shared combustion chamber.

According to an exemplary embodiment, during peak load operation the compound engine is operated by way of the gas turbine. This provides an advantage in that the air mass throughput of the gas engine during peak load operation is high, and the drive can thus be operated in a weight-efficient manner. In this mode of operation the diesel engine can be switched off, can run along as a naturally aspirated engine without a turbocharger, or can be charged with bleed air from the low-pressure turbine. In peak load operation the gas turbine can thus be operated on its own. As an alternative, the gas turbine and the diesel engine can be used concurrently.

According to an exemplary embodiment, during continuous duty operation the compound engine is operated only by way of the diesel engine, wherein at least one compressor and at least one turbine can be used as part of the turbocharger for the diesel engine. During continuous duty operation the diesel engine can thus be operated alone or the diesel engine can be operated with part of the gas turbine as a turbocharger. Thus the compound engine can be operated by way of the diesel engine or the gas turbine. As a result of the pre-compression by means of the turbocharger, compression by the piston of the engine is reduced, as is the stroke required with it, as well as the mass and the design space of the diesel engine.

If the compound engine is operated solely by way of the diesel engine, the air flows and exhaust gas mass flows differ when compared to a combined drive by way of the diesel engine and the gas turbine, as well as when compared to pure drive by means of the gas turbine. This difference in the air flows and exhaust gas mass flows in the various operating modes is caused by the different stoichiometry in the combustion process of the diesel engine and the gas turbine, i.e. by the different ratio of air to fuel in the diesel engine or in the gas turbine.

In particular in the case of low air mass flows during operation of the compound engine by way of the diesel engine it can be advantageous not to lead the exhaust gases of the diesel engine through all the components of the gas turbine because with a low air mass flow that passes through several compressors and turbines, i.e. if several gas turbines are used as turbochargers for the diesel engine, only modest compression may be achieved, and thus in diesel engine operation with turbocharger only a modest improvement in output results. This means that the use of a single compressor and a single turbine as a turbocharger for the diesel engine can result in high compression of the air and thus to improved increase in the output of the diesel engine.

The gas turbine can, for example, comprise a multi-stage compressor, of which only a part, in particular a compressor stage, is used as a turbocharger for the diesel engine.

According to an exemplary embodiment, the compound engine comprises shutoff valves, for example for regulating the fresh air supply, for regulating the gas supply to the combustion chamber, for regulating the gas supply to the turbines. In peak load operation the shutoff valves are open, thus making it possible to operate every compressor and every turbine, while during continuous duty operation the valves only make it possible to operate those compressors and those turbines that are used as turbochargers for the diesel engine.

According to an exemplary embodiment, the compound engine comprises a first driven shaft, a first clutch, a first transmission, a second transmission and a main driven shaft, wherein the first driven shaft of the gas turbine is connected to the main driven shaft by way of the first transmission, by way of the first clutch and by way of the second transmission.

According to an exemplary embodiment, the compound engine further comprises a second driven shaft and a second clutch, wherein the second driven shaft of the diesel engine is connected to the second transmission by way of the second clutch, and the second transmission is connected to the main driven shaft.

The driven shafts of the gas turbine and the diesel engine operate at different rotary speeds, and the mechanical output of each shaft can be brought to a shared main driven shaft by way of the respective transmissions. If only the gas turbine or the diesel engine is operating, the driven shaft of the inactive component can be separated from the transmission by means of a clutch. This is, furthermore, advantageous for safety reasons because by way of the corresponding clutches the components can at any time be separated from the transmission.

According to an exemplary embodiment, the compound engine furthermore comprises a third clutch, wherein a turbine used for the turbocharger can be separated from the first transmission by way of the third clutch.

If part of the gas turbine is used as a turbocharger for the diesel engine, this part is decoupled from operation of the gas turbine by means of corresponding clutches and valves. Consequently, concurrent use of the diesel engine with the turbocharger and the remainder of the gas turbine is possible.

According to an exemplary embodiment, the gas turbine is serially connected in the manner of a classical multi-shaft engine, wherein the gas turbine comprises high-pressure and low-pressure turbines and high-pressure and low-pressure compressors, wherein the low-pressure compressor and the low-pressure turbine or the high-pressure compressor and the high-pressure turbine run on separate shafts. This provides an advantage in that low-pressure and high-pressure turbines can operate at different rotary speeds. Optionally, on a further, separate, shaft, a power turbine can be connected downstream. The separate shafts can be designed individually or can be combined in a hollow shaft. The turbines and compressors can be implemented in separate components or can be integrated in a shared housing.

The smaller dimensions of the high-pressure part when compared to the low-pressure part of the gas turbine make it possible to operate the turbocharger in diesel operation with lower air mass flow rates. Since the flow conditions in both operating modes are similar, that part of the gas turbine that operates in the high-pressure region can be used as a turbocharger for diesel operation, while that part of the gas turbine that operates at low pressure is not used for the turbocharger. The power turbine can optionally run along in turbocharger operation and can utilize remaining energy of the exhaust gas air. In this case the transmission is not separated from the power turbine by means of a clutch. The high-pressure part can be designed for a shared operating point. This operating point can be adjusted to the respective operating mode by means of adjustment of the guide wheel.

According to an exemplary embodiment, the compound engine comprises generators that at least in part replace the clutches and mechanical transmissions. For example, no clutches and mechanical transmissions are provided; instead, there are electrical transmissions that generate electrical power by way of generators. The effective output at the driven shafts can thus be utilized not only mechanically but also electrically. The generators transform the mechanical output of the respective driven shafts to electrical output and the latter can, with the use of power electronics, for example an output regulator, be used as an electrical drive or can be fed to a consumer network.

According to an exemplary embodiment, the compound engine is used in a means of transport. Likewise, the compound engine can be used in a stationary system if this system has, for example, both base load requirements and peak load requirements, and saving weight is an important consideration.

According to a second aspect of the invention, a means of transport with a compound engine is provided, wherein the means of transport can be an aircraft, a helicopter, a vertical takeoff aircraft or a water craft or some other means of transport in which the difference between base load operation and peak load operation is correspondingly great.

According to a third aspect of the invention, a method for driving a means of transport is provided, which method, for example, involves the following steps: from driving a means of transport by means of a gas turbine, wherein at the same time the diesel engine can be operated, a changeover takes place to driving the means of transport by means of a diesel engine. When driving the means of transport by means of a diesel engine, part of the gas turbine can be utilized as a turbocharger for the diesel engine.

According to a fourth aspect of the invention, a method for driving a means of transport is provided, which method, for example, involves the following steps: from driving a means of transport by means of a diesel engine, wherein part of the gas engine can be utilized as a turbocharger, switchover to driving the means of transport by means of a gas turbine takes place. Subsequently, driving the means of transport by means of a gas turbine can take place, wherein at the same time the diesel engine can be operated.

### BRIEF DESCRIPTION OF THE DRAWINGS

Below, exemplary embodiments are described with reference to the following drawings.

FIG. 1 diagrammatically shows a compound engine 100 that comprises a gas turbine 101 and a diesel engine 16, wherein part of the gas turbine 101 can be used as a turbocharger 102 for the diesel engine 16.

FIG. 2 shows a circuit diagram for a parallel arrangement of compressors 11, 12 and turbines 17, 18.

FIG. 3 shows a circuit diagram for a serial arrangement of compressors 301, 302 and turbines 303, 304 with a power turbine 305.

FIG. 4 shows a circuit diagram for a serial arrangement of compressors 301, 302 and turbines 303, 304 without the power turbine 305.

FIG. 5 shows a further exemplary embodiment with an electrical transmission 501, 502. By way of an output regulator 503 the generated electrical power can also be fed to a consumer network by way of a corresponding line 504.

FIG. 6 shows a block diagram of a method for driving a means of transport and switching from one drive to another drive of a means of transport.

FIG. 7 shows a block diagram of a method for driving a means of transport and switching from one drive to another drive of a means of transport.

FIG. 8 shows an aircraft 800 with compound engines 100.

FIG. 9 shows a helicopter 900 with a compound engine 100.

### DETAILED DESCRIPTION

The illustration in the figures is diagrammatic and not to scale. The same reference characters are used for identical or similar elements.

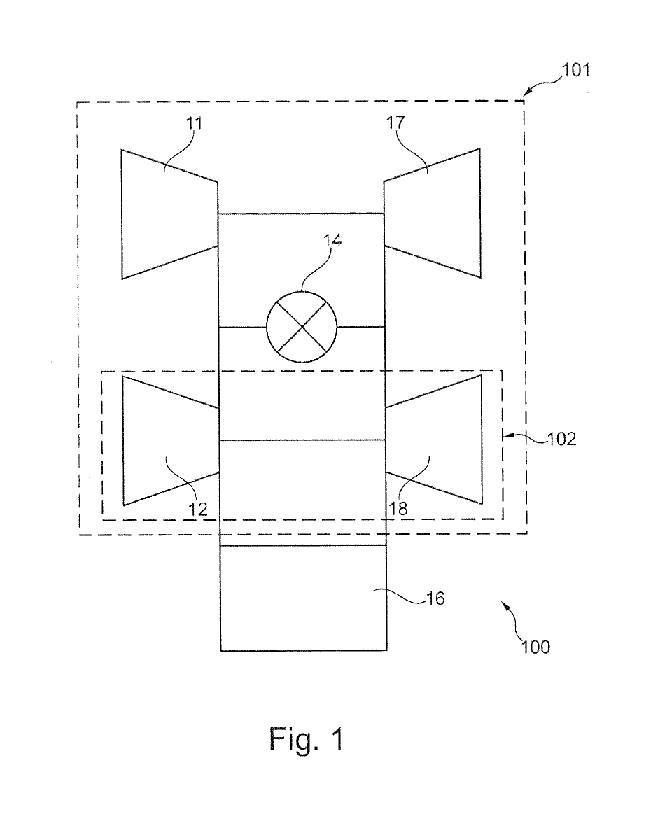

FIG. 1 diagrammatically shows a compound engine 100 comprising a gas turbine 101 and a diesel engine 16, wherein part of the gas turbine 101 can be used as a turbocharger 102 for the diesel engine 16. The combustion chamber 14 can be a shared combustion chamber for the compressors 11, 12 and the turbines 17, 18, or several combustion chambers can be used.

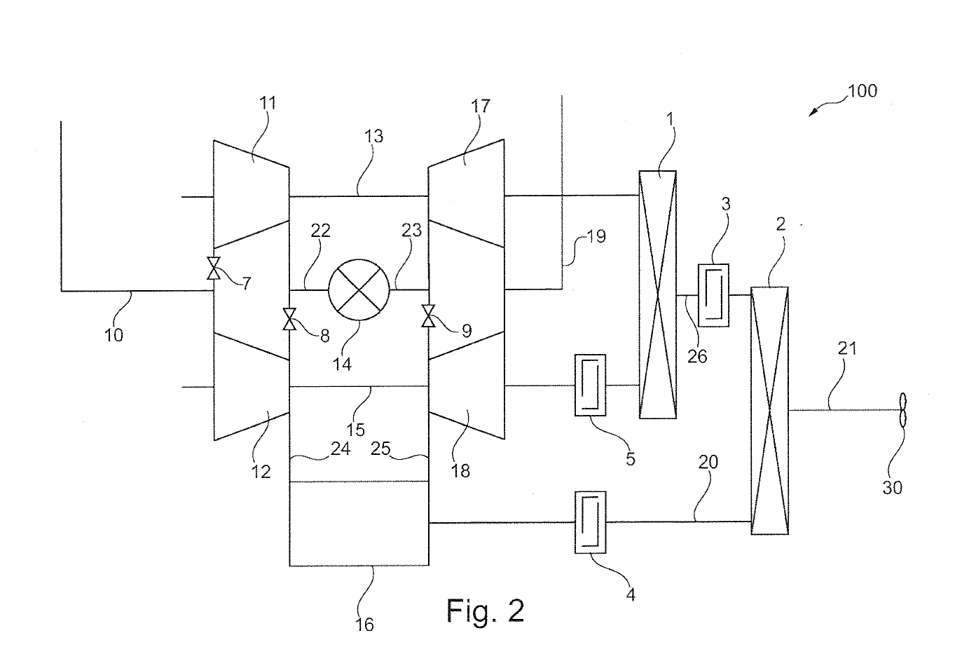

FIG. 2 shows a circuit diagram for a compound engine 100 for a parallel arrangement of compressors 11, 12 and turbines 17, 18 and a diesel engine 16 as well as mechanical transmissions 1, 2. In this design the compressor 11 and the turbine 17 are arranged on a shaft 13, the compressor 12 and the turbine 18 are arranged on a further shaft 15, and the diesel engine is also arranged on its own shaft 20.

In the concept shown, air is channeled, by way of the fresh air supply 10, into the compressors 11, 12 where it is compressed. From there it can reach the combustion chamber 14 by way of a line arrangement 22, in which combustion chamber 14 the gas is heated. By means of a line arrangement 23 the heated gas moves from the combustion chamber 14 to the turbines 17, 18, by means of which turbines 17, 18 torque for the respective shaft 13, 15 is generated. By way of an exhaust gas system 19 the exhaust gas is removed from the system.

It is possible for the respective line arrangements and the exhaust gas system to be utilized in a shared manner by the components of both shafts, but it is also possible for the respective lines and guides to be designed so as to be separate for each shaft.

The shafts 13, 15 are coupled to a first transmission 1, wherein in turbocharger operation the shaft 15 can be decoupled from the transmission 1 by means of a clutch 5. By means of a line arrangement 25 the diesel engine 16 can be connected to one of the turbines 18 which in turbocharger operation utilizes the energy of the exhaust gas in order to drive a compressor 12, by way of the shaft 15, which compressor 12 can supply pre-compressed air to the diesel engine 16 by way of a line arrangement 24. By way of the valves 7, 8, 9 the air circuit can be closed off from the unused part of the gas turbine. The diesel engine 16 runs on a crankshaft 20 that is coupled to a transmission 2 and that can be decoupled from the transmission 2 by way of a clutch 4. The transmission 2 in turn is connected to a main driven shaft 21 that can, for example, drive a propeller 30.

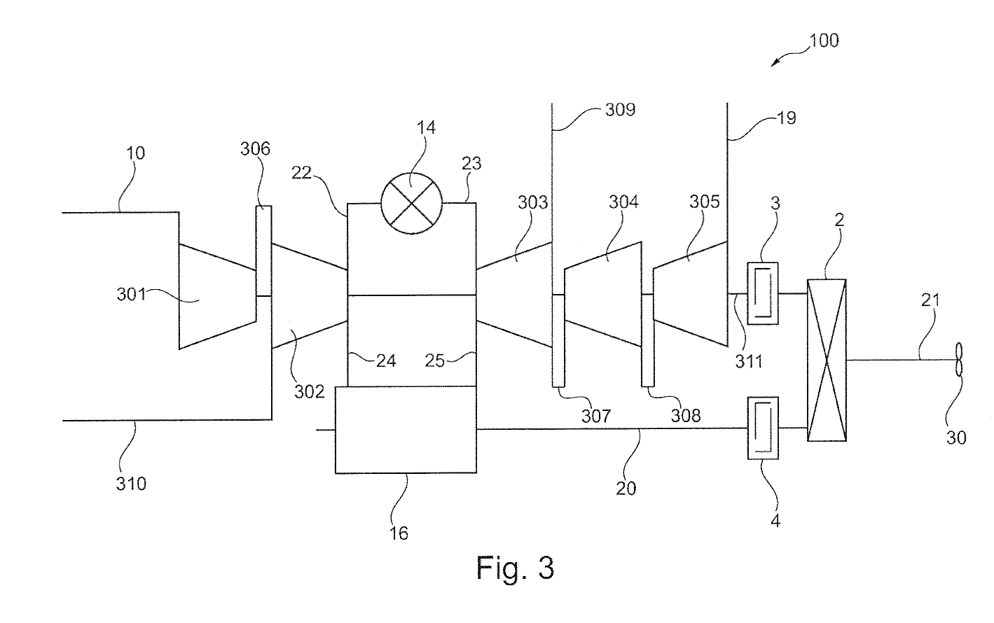

FIG. 3 shows a circuit diagram for a compound engine 100 for a serial arrangement of compressors 301, 302 and turbines 303, 304, 305 and a diesel engine 16 as well as a mechanical transmission 2. This arrangement comprises a low-pressure compressor 301, a high-pressure compressor 302, a high-pressure turbine 303, a low-pressure turbine 304 and a power turbine 305. The low-pressure compressor 301 and the low-pressure turbine 304 are arranged on a shaft; the high-pressure compressor 302 and the high-pressure turbine 303 are arranged on a further shaft; and the power turbine 305 is arranged on yet another shaft.

The separate shafts are represented by one shaft 311. This can, for example, be implemented by a hollow shaft. Air is fed by way of a fresh air supply 10 to the low-pressure compressor 301 where said air is pre-compressed. By way of the line arrangement 306 the pre-compressed air reaches the high-pressure compressor 302, which further compresses the air. By way of the line 22 the compressed air reaches the combustion chamber 14, where it is heated, and by way of the line 23 it reaches the high-pressure turbine 303; furthermore, by way of a line arrangement 307 it reaches the low-pressure turbine 304 and by way of a further line arrangement 308 it reaches the power turbine 305, where in each case, by means of the removal of energy from the heated gas, a torque is generated. An exhaust gas system 309 leads the exhaust gas from the high-pressure turbine from the system; an exhaust gas system 19 leads the exhaust gas from the power turbine from the system. The low-pressure turbine can also comprise an exhaust gas system.

When the power turbine is in operation, only the exhaust gas system 19 is open; the exhaust gas system 309 is closed. By way of a clutch 3 the shaft 311 is connected to the transmission 2. The diesel engine 16 is connected to the transmission 2 by way of the crankshaft 20 by way of the clutch 4, which transmission 2 in turn is connected to the main driven shaft 21. The compressor 302 and the turbine 303 of the gas turbine, which both operate at high pressure, can serve as parts of the turbocharger 102. By means of a line 25 the diesel engine 16 can be connected to one of the turbines 303 which utilizes the energy of the exhaust gas in order to, by way of the shaft 311, drive a compressor 302 which by way of the line 24 can supply pre-compressed air to the diesel engine 16. In this case the fresh air for the compressor 302 emanates from a fresh air supply 310, because in turbocharger operation the fresh air supply 10 is closed by way of a corresponding valve.

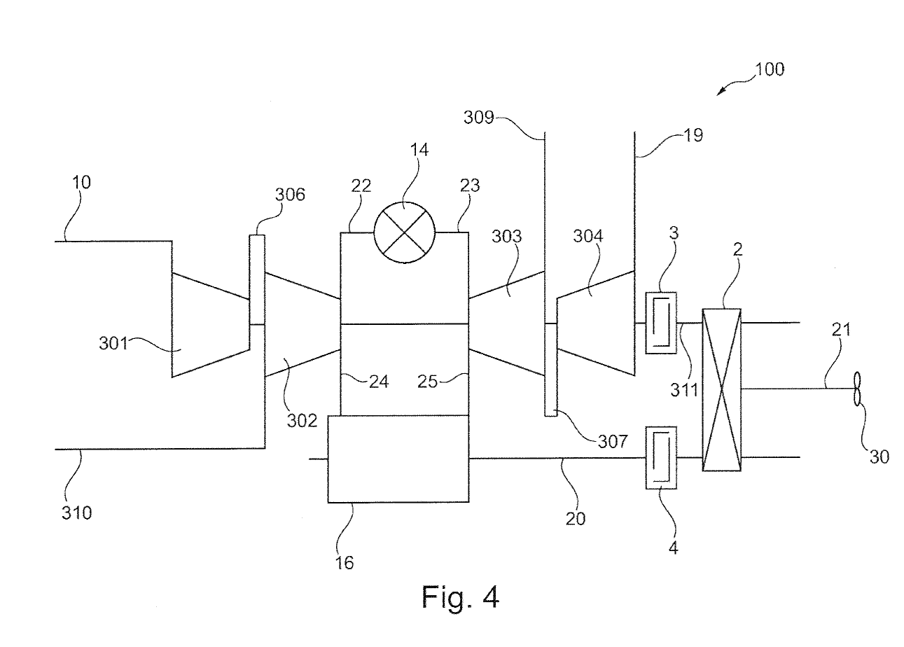

FIG. 4 shows the arrangement of FIG. 3 without a power turbine. In this case the exhaust air is removed from the system by way of the exhaust gas system 19 on the low-pressure turbine 304 instead of on the power turbine 305.

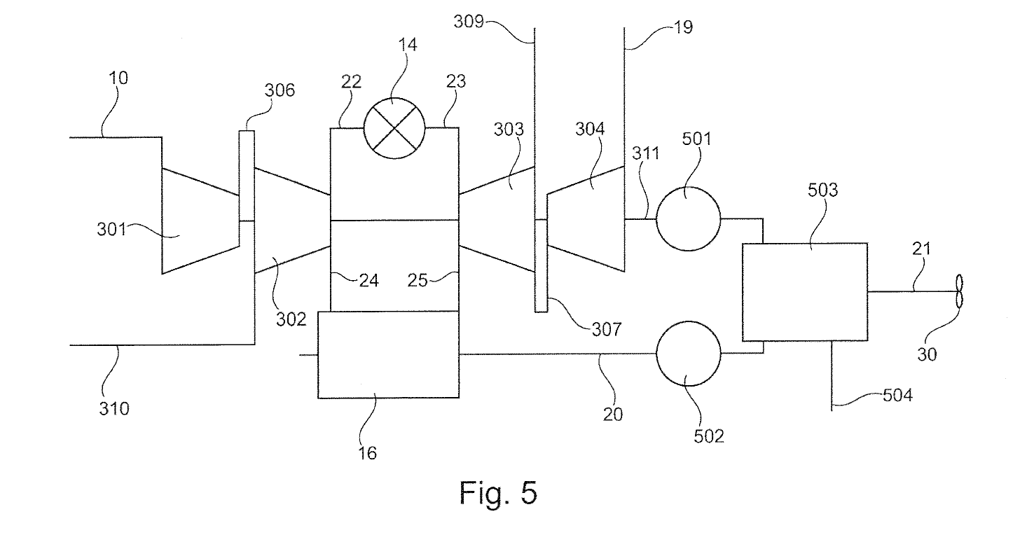

FIG. 5 shows the arrangement of FIG. 4 without a mechanical transmission 2 and instead with generators 501, 502, wherein the electrical power generated by the generators can be used to drive the main driven shaft 21 or can be fed to a consumer network by way of a line 504. An output regulator 503 can be used to combine the electrical power from the generators, which generators can operate at different rotary speeds, voltages and frequencies, to form a common voltage and frequency.

For reconversion to mechanical energy a separate electric motor can be provided.

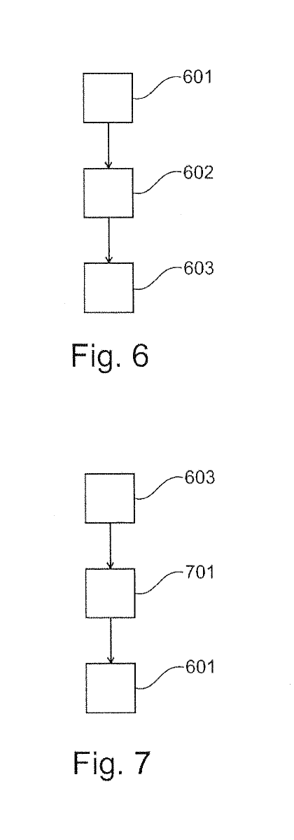

FIG. 6 shows a block diagram of a method for driving a means of transport and switching from one drive to another drive of a means of transport. In step 601 driving a means of transport by means of a gas turbine takes place, wherein the diesel engine may operate as well. In step 602 switching from the gas turbine to the diesel engine takes place. In step 603 driving the means of transport with the diesel engine takes place, wherein part of the gas turbine can be, or is, used as a turbocharger for the diesel engine.

FIG. 7 shows a block diagram of a method for driving a means of transport, in which method in step 603 driving the means of transport by means of a diesel engine takes place, wherein part of the gas turbine can be used as a turbocharger for the diesel engine. In step 701 switching from the diesel engine to the gas turbine takes place. In step 601 driving the means of transport by means of a gas turbine then takes place, wherein the diesel engine may operate as well.

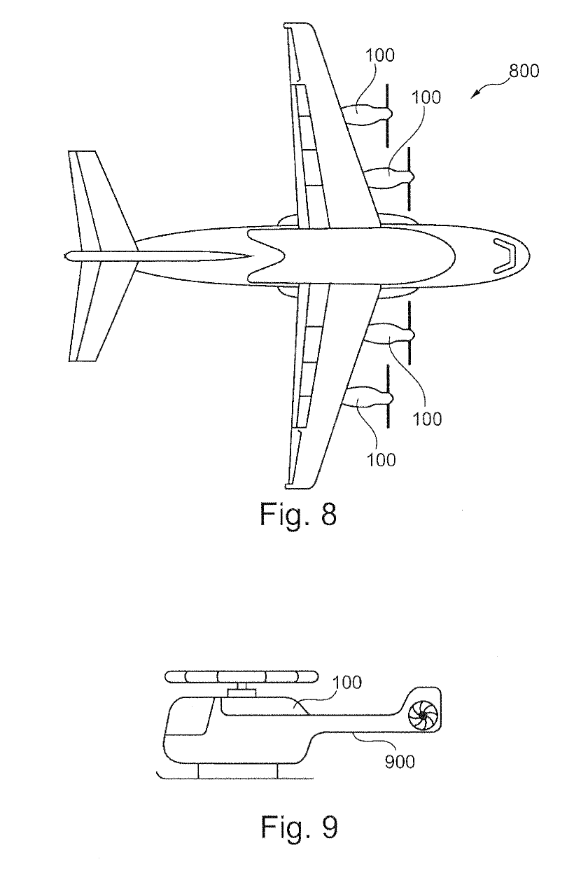

FIG. 8 shows an aircraft 800 with several compound engines 100.

FIG. 9 shows a helicopter 900 with a compound engine 100, wherein the compound engine 100 can be accommodated, entirely or partly, directly on the rotor, underneath or in the helicopter.

Below, exemplary key data are provided:

| Diesel | Gas turbine |
|---|---|
| 500 kW mechanical | PW 120 |
| 40% efficiency | 4 g/kW air mass flow |
| 1250 kW thermal | 8.88e−05 kg/kW/s peak load |
| 42500 kJ/kg energy content of diesel | SFC (specific fuel consumption) |
| 30 g/s fuel mass flow | 26.5% efficiency |
| 14.5 kg/kg air requirement of diesel fuel | PW 127 |
| 0.426 kg/s stoich. air mass flow | 7.1 kg/s air mass flow |
| 1 kg/s air mass flow at λ = 2 | Compression ratio 1:16 |
| Compression ratio 1:23 | |

It should be pointed out that the term “comprising” does not exclude further elements or method-related steps, and the term “a” or “an” does not exclude several elements and steps. The reference characters used are only intended to provide a better understanding; they should on no account be interpreted as limiting, wherein the scope of protection of the invention is defined by the claims.

1. A compound engine for a means of transport comprising:
a diesel engine,
a gas turbine with at least one compressor and with at least one turbine, wherein the diesel engine and the gas turbine are interconnected in such a manner that during continuous duty operation the compound engine is configured to be operated only by way of the diesel engine, and the diesel engine is optionally operated on its own or together with a compressor and a turbine of the gas turbine as a turbocharger for the diesel engine; and
wherein the compound engine is configured to be operated by way of the diesel engine or the gas turbine.

2. The compound engine of claim 1, wherein the gas turbine comprises first and second separate compressors and first and second turbines.

3. The compound engine of claim 2, further comprising: a shared combustion chamber for the first and second turbines.

4. The compound engine of claim 1, wherein during peak load operation the compound engine is configured to be operated only by way of the gas turbine, or the diesel engine is configured to operate as a naturally aspirated engine or a charged engine.

5. The compound engine of claim 1, wherein the compound engine comprises a shutoff valve for regulating the fresh air supply, for regulating the gas supply to the combustion chamber, or for regulating the gas supply to one of the turbines;
wherein the shutoff valve is open during peak load operation, and in continuous duty operation makes it possible to operate only that turbine used as a turbocharger for the diesel engine.

6. The compound engine of claim 1, further comprising:
a first driven shaft;
a first clutch;
a first transmission;
a second transmission;
a main driven shaft;
wherein the first driven shaft of the gas turbine is connected to the main driven shaft by way of the first transmission, by way of the first clutch and by way of the second transmission.

7. The compound engine of claim 6, further comprising:
a second driven shaft;
a second clutch;
wherein the diesel engine is connected to the second transmission by way of the second driven shaft and by way of the second clutch;
wherein the second transmission is connected to the main driven shaft.

8. The compound engine of claim 6, further comprising:
a third clutch;
wherein a turbine used for the turbocharger is configured to be separated from the first transmission by the third clutch.

9. The compound engine of claim 1, further comprising:
a high-pressure turbine;
a low-pressure turbine;
a high-pressure compressor;
a low-pressure compressor;
wherein the compressors and turbines are serially connected in the gas turbine;
wherein the high-pressure turbine and the high-pressure compressor form part of the turbocharger;
wherein the low-pressure turbine and the low-pressure compressor do not form part of the turbocharger.

10. The compound engine of claim 6, further comprising:
a first generator;
a second generator;
an output regulator;
wherein the first driven shaft of the gas turbine with the first generator is connected to a consumer network by way of the output regulator, and
wherein the second driven shaft of the diesel engine with the second generator is connected to a consumer network by way of the output regulator.

11. A means of transport comprising a compound engine, the compound engine comprising:
a diesel engine,
a gas turbine with at least one compressor and with at least one turbine,
wherein the diesel engine and the gas turbine are interconnected in such a manner that during continuous duty operation the compound engine is configured to be operated only by way of the diesel engine, and the diesel engine is optionally operated on its own or together with a compressor and a turbine of the gas turbine as a turbocharger for the diesel engine,
wherein the compound engine is configured to be operated by way of the diesel engine or the gas turbine; and
wherein the means of transport is an aircraft, a helicopter, a vertical takeoff aircraft or a water craft.

12. A method for driving a means of transport, comprising:
driving the means of transport with at least one gas turbine with at least one compressor and at least one turbine;
switching driving the means of transport by the gas turbine to driving the means of transport only by a diesel engine; and
driving the means of transport by the diesel engine, wherein in a continuous duty operation the means of transport is operated only by way of the diesel engine, and the diesel engine is optionally utilized on its own or with a compressor and a turbine of the gas turbine as a turbocharger for the diesel engine.

13. A method for driving a means of transport, comprising:
driving the means of transport by a diesel engine, wherein in a continuous duty operation the means of transport is only operated by way of the diesel engine, and the diesel engine is optionally utilized on its own or with a compressor and a turbine of a gas turbine as a turbocharger for the diesel engine;
switching from driving the means of transport by the diesel engine to driving the means of transport by the gas turbine; and
driving the means of transport by at least the gas turbine.
